(19) United States
(12) Patent Application Publication
(10) Pub. No.: US 2017/0210968 A1
(43) Pub. Date: Jul. 27, 2017

(54) RESERVOIR TREATMENT FLUID

(71) Applicants: Amir MIRZAEI, Calgary (CA); Hirbod RAD, Calgary (CA)

(72) Inventors: Amir MIRZAEI, Calgary (CA); Hirbod RAD, Calgary (CA)

(21) Appl. No.: 15/326,304

(22) PCT Filed: Jul. 14, 2015
(86) PCT No.: PCT/CA2015/000431

§ 371 Date: Jan. 13, 2017

(51) Int. Cl. C09K 8/52; C09K 8/40; E21B 43/25; E21B 33/14; E21B 37/00; E21B 21/00; C09K 8/72; C09K 8/42

(52) U.S. Cl. CPC C09K 8/52; C09K 8/72; C09K 8/40; C09K 8/424; E21B 33/14; E21B 37/00; E21B 21/00; E21B 43/25; C09K 2208/32

(57) ABSTRACT

An oil and gas reservoir treatment solution composition comprises an amino acid hydrochloride or esterified amino acid hydrochloride. The treatment fluid composition can be used to remove the formation damage or the filter cake after the drilling operation. The treatment fluid may also be used as part or all of a spearhead, preflush, spacer, post flush, matrix acidizing and fracture acidizing solution where a low pH solution can remove deposits otherwise harmful to the production of oil and gas operation.

### FIELD OF INVENTION

The present invention relates to compositions comprising acid donors and to methods of use for such compositions, including, but not limited to, removing formation damage and filter cake after the drilling operation. Removal of acid soluble deposits prior to, or during oil and gas production, cementing operation, acidizing operation and hydraulic fracturing operation. Other applications of the acid donors subject of the invention include PH adjustment in drilling fluids or any of the above mentioned operations,

### BACKGROUND OF THE INVENTION

The production of oil and gas from subterranean formations necessitates drilling into the subsurface formations thereby opening a conduit for the hydrocarbon fluids to flow to the surface production facilities. While drilling a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and. weighting material when circulation is interrupted., to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate. It will be appreciated that within the scope of the claimed invention herein, the term “drilling fluid” also encompasses “drill-in fluids” and “completion fluids”.

### Formation Damage

During this drilling and the subsequent work-over and production operations, there are numerous situations where the production rate of an oil or gas well following these operations is limited due to the presence of formation damage.

Types of damage include, but are not limited to, the presence of polymer-containing filter cakes, fluids (including hydraulic fracturing fluids) filtrates or residues including polysaccharide-containing filter cakes, fluids, filtrates or residues, particulate materials such as fluid loss control agents and rock fines, biofilms, scales and asphaltenes.

Damage can be present deeper into the formation, for example in natural or induced fractures or in the rock matrix or it can be near wellbore, for example the presence of filter cake.

Filter cakes are formed when particles suspended in a wellbore fluid coat and plug the pores in the subterranean formation such that the filter cake prevents or reduce both the loss of fluids into the formation and the influx of fluids present in the formation. A number of ways of forming filter cakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity.

Upon completion of drilling, the filter cake and/or fluid loss pill may stabilize the wellbore during subsequent completion operations such as placement of a gravel pack in the wellbore. Additionally, during completion operations, when fluid loss is suspected, a fluid loss pill of polymers may be spotted into to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filter cake (formed during drilling and/or completion) remaining on the sidewalls of the wellbore may be necessary. Although filter cake formation and use of fluid loss pills are essential to drilling and completion operations, tile barriers can be a significant impediment to the production of hydrocarbon or other fluids from the well if, for example, the rock formation is still plugged by the barrier. Because filter cake is compact, it often adheres strongly to the formation and may not be readily or completely flushed out of the formation by fluid action alone.

The problems of efficient well clean-up and completion are a significant issue in all wells, and especially in open-hole horizontal well completions. The productivity of a well is dependent on effectively and efficiently removing the filter cake while minimizing the potential of water blocking, plugging, or otherwise damaging the natural flow channels of the formation, as well as those of the completion assembly.

Damage is often caused by a combination of several components. For example, certain drilling muds or drill-in fluids contain calcium carbonate or dolomite in combination with a polymer or polymers which provides suitable rheological properties. Both the carbonate and the polymer contribute to the formation of a filter cake. Carbonate fines generated during drilling of carbonate rocks may also be present in the filter cakes.

Filter cakes generally contain high densities of polysaccharide. U.S. Pat. No. 5,247,995 cites SPE Paper 21.497 which states that they can contain, up to about 48% polysaccharide versus about 4% in fracturing fluids.

Filter cakes which do not contain carbonate may be susceptible to treatment with acid if they are present on wellbore surfaces in carbonate formations, as acid may attack the underlying carbonate and cause disruption of the filter cake.

Some of the prior art is found in the following published articles: SPE 68911 “Stimulation of a Producing Horizontal Well Using Enzymes that Generate Acid In-Situ-Case History” by Ralph E. Harris, et al., dated May 21, 2001; SPE 68933 “Evaluation of Filter Cake Flowback in Sand Control Completions” by D, Tiffin, B P; B. Stevens, OMNI Laboratories, Inc.; E. Park, B P; F. Elliott, B P; and J. Gilchrist, B P; and AADE-11-NTCE-78 “Environmentally Friendly Filtercake Removal System” by Natalia Collins, Kingsley Nzeabide and Steve Almond, Halliburton.

### Cementing

In completing wells for production, casing is usually inserted into the well bore and fixed in place by placing cement in the annular space between the casing and the well bore. Cements or cementing compositions generally used employ hydraulic cements such as Portland cement or modified Portland cements.

A spacer fluid is a liquid used to physically separate one special-purpose liquid from another. Special-purpose liquids are typically subject to contamination, so a spacer fluid compatible with each is used between the two. A common spacer fluid is simply water, but solvent-based spacers and spacers that contain a majority of mutual solvents are also typical. However, other chemicals are often added to enhance the fluid's performance for the particular operation. Spacers are used primarily when changing mud types or changing from mud to a completion fluid. In the former, an oil-based fluid must be kept separate from a water-based fluid. Another common use of spacers is to separate mud from cement during cementing operations. For cementing, a chemically treated aqueous spacer or sequence of spacers usually separates drilling mud from the cement slurry subsequently pumped downhole. Cleaning spacers are also extensively used to clean the casing, riser and other equipment after drilling a section of wellbore. Cleaning spacers not only remove the remaining drilling fluid from the wellbore, but also cuttings, weighting agent particles, e.g. barite, and other residual oily debris and contaminants.

### Acid Stimulation

Production of formation fluids, oil and gas in particular, from production wells tends to decrease over time in part due to gradual decreasing formation permeability in the vicinity of the production well. The susceptibility of fluid-bearing geological formations to treatment by chemical reagents has resulted in. the development of a number of processes which employ acidic reagents to remedy geological formations having low production rates due to their low permeability, discontinuous porosity, or to the presence of formation plugging contaminating materials which can form and accumulate on or in the formation. A significant increase in the production rates can typically be realized by an acid treatment of the formation from the production well. U.S. Pat. Nos. 4,741,844, 4,919,827 and 5,039,434 each disclose such acid treatment processes.

An acidizing composition contains a substance reactive with the formation for the purpose of enlarging passages there through, and thereby increasing the rate and amount of production of formation fluids therefrom. Acids useful with this invention include any acid which will cause an increase in the flow of fluids in the hydrocarbon-bearing formation. For example, the acid can chemically attack wellbore deposits of scale, such as iron sulfide, can solubilize carbonate deposits, solubilize wax and other deposits of objectional hydrocarbons, etc.

### Treatment Solution

Conventional acids have been used for many years to treat damage in underground formations, and to stimulate the rate of oil or gas production through various acidization procedures. Prior art treatment solutions that remove the above mentioned deposits and filter cakes often contain highly acidic and corrosive chemicals such as live hydrochloric acid (muriatic acid). Hydrochloric acid is classified as poisons under the U.S. Federal Caustic Poison Act. It can cause severe burns to all body tissues. When disposing of the spent acid, it must be treated as hazardous waste according to U.S. Environmental Protection Agency regulations. Also, conventional acids have several operational drawbacks. They react rapidly with acid soluble materials which can result in poor zonal coverage. To improve zonal coverage the use of high pressure, high rate injection is often attempted, which increases the hazards associated with their use.

Attempts have been made with other treatment solutions. Treatments for removing filter cake include: aqueous solution with an oxidizer (such as persulfate), hydrochloric acid solution, organic (acetic, formic) acid, combination of acid and oxidizer, and aqueous solutions containing enzymes. For instance, the use of enzymes to remove filter cake is disclosed in U.S. Pat. No. 4,169,818. Mixture of Hydroxypropylcellulose and Poly (Malcic Anhydride/Alley Vinyl Ether) as a Hydrocolloid Gelling Agent (1979) (col. 1, ln. 42); U.S. Pat. No. 3,515,667, Drilling Fluid Additive (1970); U.S. Pat, No. 3,509,950, Well Drilling Mud and Screen Composition of Use Thereof; U.S. Pat. No. 2,259,419, Well Drilling (1941). Chelating agents (e.g., EDTA) are also used to promote the dissolution of calcium carbonate. See, C. N. Fredd and H. S. Fogler, Chelating agents as Effective Matrix Stimulation Fluids for Carbonate Formations, SPE 37221.2 (1997); C. N. Fredd and H. S. Fogler, Alternative Stimulation Fluids and Their Impact on Carbonate Acidizing, SPE 31074 (1966), both articles are hereby incorporated by reference in their entirety. According to conventional teaching, the oxidizer and enzyme attack the polymer fraction of the filter cake; the acids mainly attack the carbonate fraction (and other minerals). Generally speaking, oxidizers and enzymes are ineffective in degrading the carbonate fraction; likewise, weaker acids have very little effect on polymers.

Citric acid, with and without incorporation of other ingredients has been attempted as a filter cake remover. Citric acid is much less hazardous than the mineral acids and due to its relatively low acid strength takes much longer to eat through the cake. But the calcium and magnesium citrates which form when citric acid is allowed, to react with calcium and magnesium carbonates and hydroxides are only slightly soluble in water and therefore the deposits do not wash, away easily. The solubility of these salts increases if an excess of citric acid is used, but even then the citric acid is not as effective in removing carbonate deposits as are the foregoing strong mineral acids.

Various combinations of surfactants, acids and solvents have also been used as spacer fluids or pre-flush and post-flush solutions in cementing and fracturing operations.

### SUMMARY OF THE INVENTION

The present invention relates to fluids containing acid donors for damage removal and/or PH adjustment of drilling fluids and/or deposit removing solutions used prior to, during of and after cementing, acid stimulation and hydraulic fracturing operation of subterranean formations. The acid, donors of the present invention release halogen acid upon hydrolysis and, therefore, effect a greater diffusion through the matrix. Although any compounds which produce halogen acid would be suitable in the practice of the instant invention, preferred acid donors include amino acid hydrochlorides and esterified amino acid hydrochloride such as trimethylated amino acid hydrochloride otherwise known as betaine hydrochloride. The preferred amino acid and amino acid based hydrochlorides and their optical isomers are glycine hydrochloride, glutamic acid hydrochloride, betaine hydrochloride, alanine hydrochloride, valine hydrochloride, lysine hydrochloride, arginine hydrochloride and aspartic acid hydrochloride. The treatment containing the acid donors of the present invention may or may not contain water, surfactants, hydrocarbon solvents, thickeners, abrasives, dispersants, foaming agents, emulsifiers, enzymes, chelants and/or corrosion inhibitors.

It is an object of the present invention to provide a simple and effective formation damage removing composition within an underground reservoir, which avoids the toxicity, health hazards, and environmental hazards of strong mineral acids such as hydrochloric acid and sulfamic acid.

It is also an object of the present invention to provide a formation damage removing composition which is less corrosive to metal surfaces than strong mineral acids.

It is a further object of the present invention to provide a formation damage removal and remediation treatment for horizontal wells where the long intervals and flash reaction of strong mineral, acids prevents uniform treatment and remediation of the damaged zone.

It is another object of the present reaction to provide a formation damage removing composition which is more effective than citric acid and weak acid releasing carboxylic acid esters.

It is yet another object of the present invention to provide single stage treatment methods which can remove damage and provide further stimulation of production or injection rate by increasing the matrix permeability of adjacent undamaged regions of the formation.

It is a further object of the present invention to provide methods which are environmentally acceptable by utilising components which are of low environmental impact.

Accordingly, the present invention provides a method for treating an underground reservoir, which method involves introducing into the reservoir a treatment fluid comprising of amino acid hydrochlorides and/or esterified amino acid hydrochlorides as environmentally benign acid donors,

According to a first aspect of the present invention, there is provided a method for the treatment of subterranean formations comprising the application of a composition comprising one or more of amino acid hydrochloride or esterified amino acid hydrochloride as one of the acidic components or the main acidic component of the treatment composition to the surface or inside the subterranean formation to donate the acid or make an acidic solution. Preferably, the amino acid hydrochloride consists of at least one amino acid and 0.0001% to 99.999% hydrochloride. Preferably also, the esterified amino acid hydrochloride is betaine hydrochloride. Further, the amino acid hydrochloride is preferably contacted with water prior to the application to the surface or inside the subterranean formation, to donate the acid or make an acidic solution. More preferably, the hydrochloride is placed in the formation. Preferably, the amino acid or the esterified amino acid has been reacted with other halogen acids such as hydrofluoric acid, hydrobromic acid and hydroiodic acid or a combination thereof with or without hydrochloric acid to produce the relevant acid donating product.

More preferably, the composition comprises at least one of the following: water; a surfactant; hydrocarbon solvent: a thickener; an abrasive; a dispersant; a foaming agent; an emulsifier; an enzyme; a chelant and a corrosion inhibitor.

According to another aspect of the present invention, the composition referred to above can be used for filter cake removal after drilling operation.

According to another aspect of the present invention, there is provided a composition for treatment of subterranean formations comprising:
0.1-99.9 % water;
0.1-65% betaine hydrochloride; and
0.1-99.9 % of at least one other ingredient selected, from the group consisting of: surfactants, hydrocarbon solvents; thickeners; abrasives; dispersants; foaming agents; emulsifiers; enzymes; chelants; and corrosion inhibitors.
   Preferably, the composition comprises
30-95 % water;
5-40% betaine hydrochloride; and
1-30% of at least one other ingredients selected from the group consisting of: surfactants, hydrocarbon solvents; thickeners; abrasives; dispersants; foaming agents; emulsifiers; enzymes; chelants; and corrosion inhibitors.
   More preferably, the composition comprises
60-95 % water;
5-25% betaine hydrochloride; and
1-25% of at least one other ingredients selected from, the group consisting of: surfactants, hydrocarbon solvents; thickeners; abrasives; dispersants; foaming agents; emulsifiers; enzymes; chelants; and corrosion inhibitors.
   Even more preferably, the composition comprises
90% water;
7% betaine hydrochloride; and
3% of at least one other ingredients selected from the group consisting of: surfactants, hydrocarbon solvents; thickeners; abrasives; dispersants; foaming agents; emulsifiers; enzymes; chelants; and corrosion inhibitors.

According to another aspect of the present invention, there is provided a method, as set out above where the composition is used as a spearhead in acid stimulation of subterranean formations.

According to yet another aspect of the present invention, there is provided a method as set out above where the composition is used as a preflush solution in acid stimulation of subterranean formations.

According to another aspect of the present invention, there is provided a composition as set out above for use as a spacer solution in acid stimulation of subterranean formations.

According to another aspect of the present invention, there is provided a composition as set out above for use in matrix acidization of subterranean formations.

According to another aspect of the present invention, there is provided a composition as set out above for use in fracture acidization of subterranean formations.

According to another aspect of the present invention, there is provided a composition as set out above for use as a postflush solution in acid stimulation of subterranean formations.

According to another aspect of the present invention, there is provided a composition as set out above for use as a spearhead solution in cementing operation.

According to yet another aspect of the present invention, there is provided a composition as set out above for use as a preflush solution in cementing operation.

According to another aspect of the present invention, there is provided a composition as set out above for use as a spacer solution in cementing operation.

According to another aspect of the present invention, there is provided a composition as set out above for use as a postflush solution in cementing operation.

According to yet another aspect of the present invention, there is provided a method of adjusting the pH of drilling fluids by the addition of a composition as set out above.

The reservoir may be a hydrocarbon, such as gas or oil, reservoir. Alternatively, the reservoir may be a water reservoir.

### BRIEF DESCRIPTION OF THE FIGURES

The invention may be more completely understood in consideration of the following description of various embodiments of the invention in connection with the accompanying figure, in which:

FIG. 1 is a graph comparing the corrosion performance of various acid compositions versus the embodiment of Example 1.

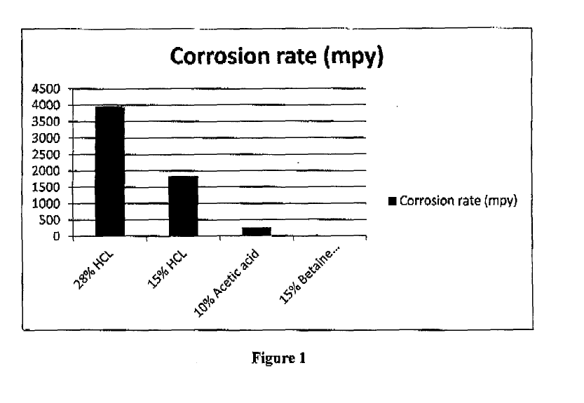

### DETAILED DESCRIPTION OF THE PREFERRED EMBODIMENTS

In comparison to certain weak acids and/or acid releasing agents which have previously been employed as mentioned, in the above disclosure of the prior art (e.g., citric acid, formic acid, acetic acid, various carboxylic acid esters which would dissociate into their components upon contact with water, given sufficient time and temperature, thereby releasing the acidic constituents into the formation to be treated , etc.), the acid donors of the present invention release halogen acid and therefore, effect a greater diffusion through the matrix. Although any compound which produces halogen acid would be suitable in the practice of the instant invention, preferred acid donors include amino acid hydrochlorides and esterified amino acid hydrochloride such as trimethylated amino acid hydrochloride otherwise known as betaine hydrochloride. The preferred amino acid and esterified amino acid hydrochlorides and their optical isomers are glycine hydrochloride, glutamic acid hydrochloride, betaine hydrochloride, alanine hydrochloride, valine hydrochloride, lysine hydrochloride, arginine hydrochloride and aspartic acid hydrochloride. The more preferred amino acid hydrochlorides are glutamic acid hydrochloride and betaine hydrochloride. The most preferred acid donor is betaine hydrochloride.

Betaine is widely distributed in plants and animals. Betaine hydrochloride, included in the present invention, is used medically as a lipotropic agent. It is included also in a commercially available over-the-counter “multiple digestive enzyme formula” for human consumption. Its use for human consumption as a nutritional supplement, for “heart strengthening and aging retardation”, as an artificial gastric juice, and m the treatment of digestive-tract disorders of domestic animals is taught in the patent literature. Likewise, glutamic acid hydrochloride, also included in the present invention, is claimed to be useful as a stomach acidifier in over-the-counter products and as a component of beverages. Glycine hydrochloride is used as an artificial gastric juice, given to patients with chronic gastritis. The patent literature claims its use at 1.5 parts in a hair dye composition that is said to be stable and non-irritating to the skin. It is also used in an aqueous solution of a meat aroma composition, which is sprayed on precooked noodles or rice.

It has been found that, not only does the inventive compound serve to replace more acidic and corrosive substances, but the above mentioned hydrochlorides have been found to promote slower reaction rates than the so-called live strong acids interacting with the substrates, thus reacting in such a manner as would a base, neutralizer, or an inhibitor. For example, when hydrochloric acid is placed on a metal, such as aluminum or steel, a violent corrosive reaction takes place, thus gassing off (fuming) and corroding the metal surface instantly. In addition, the fumes are corrosive as well. However, when the above mentioned hydrochlorides are added to the hydrochloric acid or added to water to make up a treatment solution and then added on the metal surface, the reaction is substantially immediately inhibited, and the corrosion and fuming stops. This same effect has been noted with other traditional acids such as sulfuric acid, phosphoric acid, urea hydrochloride, and glycolic acid. This corrosion inhibition can be effected in a wide range of concentrations, from 0.01 % to the solubility limit of the individual hydrochloride.

In a non-limiting, preferred embodiment of this invention hydrochloric acid is the preferred acid reacting with the above mentioned amino acids or esterified amino acids to produce hydrochlorides of the reacting amino acid or esterified amino acid. However, other halogen acids or non-limiting combinations of halogen acids such as hydrobromic acid, hydrofluoric acid and hydroiodic acid can be used to produce the relevant addition product.

Aqueous strong acids like hydrochloric acid have been found effective to break a drilling fluid filter cake mass. While acid reaction with carbonate component of the filter cakes seems to follow simple chemistry, Starch degradation has been a subject of debate. Starch is added to the drilling fluid as a fluid loss control component and acts as a bonding material for carbonate bridging agent. While weaker acids, like citric and acetic, are not able to depolymerize the starch molecule, strong acids, like hydrochloric acid and acid donors of the present invention, are able to depolymerize the starches at the bottom hole temperature and rehydrate them into single glucose molecules, thus making the use of enzymes unnecessary. Enzymes which currently form a necessary part of weak acid filter cake removal compositions are highly susceptible to ph, salt, heat and the presence of hydrocarbons. Once the filter cake is broken, communication between the wellbore and the formation becomes open and allows fluid movement and the damage has been partially or totally remediated.

### Example 1

A composition according to the present invention was prepared by using 15% betaine hydrochloride. The composition was tested for metal corrosion impact against a number known acids commonly used. The corrosion tests involved the use of N80 steel coupons exposed for 8 hours to the various compositions at a temperature of 25° C. Table 1 list the results obtained.

TABLE 1
Corrosion test results from exposure of N80 steel
coupons for 8 hours at 25° C.

| Composition | Corrosion rate (mpy) |
|---|---|
| 28% HCL | 3950 |
| 15% HCL | 1830 |
| 10% Acetic acid | 253 |
| 15% Betaine hydrochloride | 22.5 |

While the foregoing invention has been described in some detail for purposes of clarity and understanding, it will be appreciated by those skilled in the relevant arts, once they have been made familiar with this disclosure, which various changes in form and detail can be made without departing from the true scope of the invention in the appended claims.

1. A method for the treatment of subterranean formations comprising the application of a composition comprising one or more of amino acid hydrochloride or esterified amino acid hydrochloride as one of the acidic components or the main acidic component of the treatment composition to the surface or inside the subterranean formation to donate the acid or make an acidic solution; and
the amino acid hydrochloride is contacted with water prior to the application to the surface or inside the subterranean formation to donate the acid or make an acidic solution.

2. The method according to claim 1, wherein the amino acid hydrochloride consists of at least one amino acid and 0.0001% to 99.999% hydrochloride.

3. The method according to claim 1, wherein the esterified amino acid hydrochloride is betaine hydrochloride.

4. The method according to claim 2, esterified amino acid hydrochloride is betaine hydrochloride.

5. The method according to claim 1, wherein
the composition comprises at least one of the following: water; a surfactant; hydrocarbon solvent; a thickener; an abrasive; a dispersant; a foaming agent; an emulsifier; an enzyme; a chelant and a corrosion inhibitor.

6. The method according to claim 5, wherein
the hydrochloride is placed in the formation.

7. The method according to claim 5, wherein the solution is used for filter cake removal after drilling operation.

8. A method of adjusting the pH of drilling fluids by the addition of a composition for treatment of subterranean formations, the composition comprising:
0.1-99.9% water;
0.1-65% betaine hydrochloride; and
0.1-99.9 % of at least one other ingredient selected from the group consisting of surfactants, hydrocarbon solvents; thickeners; abrasives; dispersants; foaming agents; emulsifiers; enzymes; chelants; and corrosion inhibitors.

9. A method of adjusting the pH of drilling fluids by the addition of a composition for treatment of subterranean formations, the composition comprising
30-95% water;
5-40% betaine hydrochloride; and
1-30% of at least one other ingredients selected from the group consisting of surfactants, hydrocarbon solvents; thickeners; abrasives; dispersants; foaming agents; emulsifiers; enzymes; chelants; and corrosion inhibitors.

10. A method of adjusting the pH of drilling fluids by the addition of a composition for treatment of subterranean formations, the composition comprising
60-95 % water;
5-25% betaine hydrochloride; and
1-25% of at least one other ingredients selected from the group consisting of: surfactants, hydrocarbon solvents; thickeners; abrasives; dispersants; foaming agents; emulsifiers; enzymes; chelants; and corrosion inhibitors.

11. A method of adjusting the pH of drilling fluids by the addition of a composition for treatment of subterranean formations, the composition comprising
90% water;
7% betaine hydrochloride; and
3% of at least one other ingredients selected from the group consisting of: surfactants, hydrocarbon solvents; thickeners; abrasives; dispersants; foaming agents; emulsifiers; enzymes; chelants; and corrosion inhibitors.

12. The method according to claim 1, wherein the composition is used as a spearhead in acid stimulation of subterranean formations.

13. The method according to claim 1, wherein the composition is used as a preflush solution in acid stimulation of subterranean formations.

14. The method according to claim 1, wherein the composition is used as a spacer solution in acid stimulation of subterranean formations.

15. The method according to claim 1, wherein the composition is used for matrix acidization of subterranean formations.

16. The method according to claim 1, wherein the composition is used for fracture acidization of subterranean formations.

17. The method according to claim 1, wherein the composition is used as a postflush solution in acid stimulation of subterranean formations.

18. The method according to claim 8, wherein the composition is used as at least one of a spearhead solution in cementing operation, a preflush solution in cementing operation, a spacer solution in cementing operation, a postflush solution in cementing operation.

19. The method according to claim 9, wherein the composition is used as at least one of a spearhead solution in cementing operation, a preflush solution in cementing operation, a spacer solution in cementing operation, a postflush solution in cementing operation.

20. The method according to claim 10, wherein the composition is used as at least one of a spearhead solution in cementing operation, a preflush solution in cementing operation, a spacer solution in cementing operation, a postflush solution in cementing operation.

21. The method according to claim 11, wherein the composition is used as at least one of a spearhead solution in cementing operation, a preflush solution in cementing operation, a spacer solution in cementing operation, a postflush solution in cementing operation.

22. The method according to claim 1, wherein the amino acid or the esterified amino acid has been reacted with other halogen acids such as hydrofluoric acid, hydrobromic acid and hydroiodic acid or a combination thereof with or without hydrochloric acid to produce the relevant acid donating product.

23. (canceled)
